(19) United States
(12) Patent Application Publication
(10) Pub. No.: US 2018/0052988 A1
(43) Pub. Date: Feb. 22, 2018

(54) INFORMATION PROCESSING SYSTEM, INFORMATION PROCESSING METHOD, AND PROGRAM

(71) Applicant: NEC CORPORATION, Tokyo (JP)

(72) Inventors: Jun ARIYOSHI, Tokyo (JP); Hidehiro ENDOU, Tokyo (JP)

(21) Appl. No.: 15/560,953

(22) PCT Filed: Mar. 17, 2016
(86) PCT No.: PCT/JP2016/058436

§ 371 Date: Sep. 22, 2017

(30) Foreign Application Priority Data
Mar. 23, 2015 (JP) 2015-059514

(51) Int. Cl. G06F 21/44; G01R 19/25; G01R 21/133; H04L 12/28; H04L 29/06

(52) U.S. Cl. CPC G06F 21/44; G01R 19/2513; H04L 63/08; H04L 12/2834; H04L 12/2803; G01R 21/133

(57) ABSTRACT

An information processing system includes a data acquisition unit that acquires time-series data related to power consumption of a device, a specification unit that specifies the device corresponding to the power consumption on the basis of the acquired time-series data, and an authentication information acquisition unit that acquires authentication information of the device specified by the specification unit.

### TECHNICAL FIELD

The present invention relates to an information processing system, an information processing method, and a program, and particularly, to an information processing system, an information processing method, and a program for acquiring authentication information used in an authentication procedure of a device.

### BACKGROUND ART

An example of a technique for remotely detecting and operating a household electric appliance is disclosed in Patent Document 1. In a remote detection method for an electrical device disclosed in Patent Document 1, the electrical device is specified by comparing electrical characteristics of electrical devices to be used which are registered in advance with a feature value of a waveform acquired from the electrical device by a remote operation using a mobile phone or the like. In the technique disclosed in Patent Document 1, the power consumption of a device connected to a power receptacle and a power-supply voltage applied to the device are converted into pieces of digital data by an AD converter, and the feature values thereof are transmitted to a server. Further, the server detects the position of the power receptacle having the feature value transmitted therefrom as a connection position of the device, and transmits an instruction to the power receptacle when necessary, thereby remotely operating the device.

Patent Document 2 discloses an example of an information processing apparatus that identifies an electric appliance and displays appropriate information such as recall information or an advertisement on the basis of the type information of the specified electric appliance. It is disclosed that the identification of a device may be performed using a Media Access Control (MAC) address, a port number table, version information of an Operating System (OS), and the like of the device, which are included in a response packet to a request packet transmitted to the device, and may be performed on the basis of a power consumption waveform obtained by plotting the power consumption of the device on a time-series graph.

Patent Document 3 discloses a system that detects a power waveform of a socket having a household electric appliance connected thereto, converts the detected power waveform into feature data, transmits the converted data to a server together with a terminal ID and an IP address which are set in a power supply tap. Further, the system causes the server to identify a type and operation details of the household electric appliance with the feature data by referring to a database for operation identification which is prepared in advance and then, to store the specification results as a user's action information together with time information. Thereby, the system collects information indicating the user's action.

### RELATED DOCUMENT

### Patent Document

[Patent Document 1] Japanese Laid-open Patent Publication No. 2008-109849

[Patent Document 2] Japanese Laid-open Patent Publication No. 2011-108122

[Patent Document 3] Japanese Laid-open Patent Publication No. 2011-155445

### SUMMARY OF THE INVENTION

### Problem to be Solved by the Invention

However, the techniques disclosed in the above-described patent documents adopt a configuration for acquiring a power waveform of a household electric appliance connected to a power receptacle, and specifying a type of household electric appliance connected to the power receptacle on the basis of the feature data of the power waveform. Thus, it is necessary to install a dedicated apparatus for acquiring a power waveform in each of plural power receptacles in a house, and there is an inconvenience that the installation and maintenance of the dedicated apparatus take time and labor.

The invention is contrived in view of such situations, and an object thereof is to provide an information processing system, an information processing method, and a program which allows an authentication procedure to be simplified.

### Means for Solving the Problems

In order to solve the above-described problem, the following configurations are adopted in each aspect of the present invention.

A first aspect relates to an information processing apparatus.

The information processing apparatus according to the first aspect includes a data acquisition unit that acquires time-series data related to the power consumption of a device, a specification unit that specifies the device corresponding to the power consumption on the basis of the acquired time-series data, and an authentication information acquisition unit that acquires authentication information of the device specified by the specification unit.

A second aspect relates to an information processing method performed by at least one computer.

The information processing method executed by an information processing apparatus according to the second aspect includes acquiring time-series data related to the power consumption of a device, specifying the device corresponding to the power consumption on the basis of the acquired time-series data, and acquiring authentication information of the specified device.

A third aspect relates to a communication apparatus.

The communication apparatus according to the third aspect includes a data acquisition unit that acquires time-series data related to the power consumption of a device, an authentication information acquisition unit that acquires authentication information of the device corresponding to the power consumption on the basis of the acquired time-series data, and an authentication unit that performs an authentication procedure with the device by using the authentication information.

A fourth aspect relates to a server apparatus.

The server apparatus according to the fourth aspect includes a data acquisition unit that acquires time-series data related to the power consumption of a device, a specification unit that specifies the device corresponding to the power consumption on the basis of the time-series data, and an authentication information transmission unit that transmits authentication information of the device specified by the specification unit.

Note that another aspect of the invention may relate to a program causing at least one computer to perform the method of the second aspect, or may relate to a computer-readable recording medium having the program recorded thereon. The recording medium includes a non-transitory tangible medium.

The computer program includes a computer program code for causing a computer to perform an information processing method on an information processing apparatus when the computer program is executed by the computer.

Note that any combination of the above-described components and conversion of the representation of the invention among a method, an apparatus, a system, a recording medium, a computer program, and the like, are also effective as aspects of the invention.

In addition, various components of the invention do not necessarily need to be individually and independently present. For example, plural components may be formed as a single member, a single component may be formed of plural members, a certain component may be a part of another component, or a part of a certain component and a part of another component may overlap each other.

In addition, although plural procedures are described in order in the method and computer program of the invention, the described order does not limit the order in which the plural procedures are performed. Therefore, when the method and computer program of the invention are performed, the order of the plural procedures may be changed as long as the change does not affect the content.

Furthermore, the plural procedures of the method and computer program of the invention are not limited to being performed at individually different timings. Therefore, for example, while performing a certain procedure, another procedure may occur, or the timing at which a certain procedure is performed and the timing at which another procedure is performed may overlap each other in part or in full.

### Advantageous Effects of Invention

According to the above-described aspects, it is possible to provide an information processing system, an information processing method, and a program which allows an authentication procedure to be simplified.

### BRIEF DESCRIPTION OF THE DRAWINGS

The above-described objects, other objects, features and advantages will be further apparent from the preferred example embodiments described below, and the accompanying drawings as follows.

FIG. 1 is a functional block diagram logically illustrating a configuration of an information processing system according to an example embodiment of the invention.

FIG. 2 is a conceptual diagram illustrating an example of the overall configuration of the information processing system according to the example embodiment of the invention.

FIG. 3 is a block diagram illustrating a configuration example of a computer for realizing a communication apparatus according to the example embodiment of FIG. 2.

FIG. 4 is a diagram illustrating an example of a structure of an authentication information storage unit that stores authentication information acquired by the information processing system according to the example embodiment.

FIG. 5 is a flow chart illustrating an example of an operation of the information processing system according to the example embodiment.

FIG. 6 is a functional block diagram illustrating a logical configuration of apparatuses of the information processing system according to the example embodiment of the invention.

FIG. 7 is a flow chart illustrating an example of an operation of the information processing system according to the example embodiment of the invention.

FIG. 8 is a functional block diagram illustrating a logical configuration of apparatuses of the information processing system according to the example embodiment of the invention.

FIG. 9 is a diagram illustrating an example of a structure of a device information storage unit that stores second authentication information acquired by the information processing system according to the example embodiment.

FIG. 10 is a diagram illustrating an example of a structure of the authentication information storage unit of a device which is a target for an authentication procedure performed by the information processing system according to the example embodiment.

FIG. 11 is a functional block diagram illustrating an example of a configuration of the information processing system according to the example embodiment.

FIG. 12 is a flow chart illustrating the procedure of a process of acquiring the second authentication information of the information processing system according to the example embodiment.

### DESCRIPTION OF EXAMPLE EMBODIMENTS

Hereinafter, example embodiments of the invention will be described with reference to the accompanying drawings. In all of the drawings, like reference numerals denote like components, and a description thereof will not be repeated.

### First Example Embodiment

An information processing system, an information processing method and a program according to a first example embodiment of the invention will be described below.

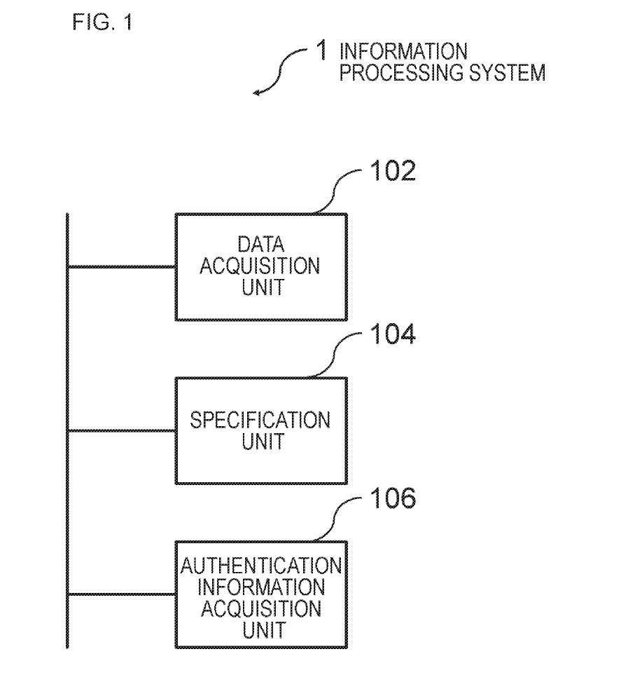

FIG. 1 is a functional block diagram logically illustrating a configuration of an information processing system 1 according to the example embodiment of the invention.

In the invention, the information processing system includes a data acquisition unit 102 that acquires time-series data related to the power consumption of a device, a specification unit 104 that specifies the device corresponding to the power consumption on the basis of the acquired time-series data, and an authentication information acquisition unit 106 that acquires authentication information of the device specified by the specification unit 104.

The information processing system 1 of the invention is realized at least by a communication apparatus that communicates with, for example, a device in a house (including, for example, ECHONET Lite (registered trademark) certified device), and is further realized by a combination with a server apparatus that provides a service of the information processing system of the invention to a user.

Plural configurations of the information processing system 1 of the invention are considered as specific configuration examples and are described below, but are not limited thereto.

(a1) A communication apparatus including the data acquisition unit 102, the specification unit 104, and the authentication information acquisition unit 106 is included.

(a2) A communication apparatus including the data acquisition unit 102, the specification unit 104, and the authentication information acquisition unit 106 and a server apparatus managing authentication information are included.

(a3) A communication apparatus including at least one of the data acquisition unit 102, the specification unit 104, and the authentication information acquisition unit 106 and a server apparatus managing authentication information are included. The server apparatus includes at least components other than the components included in the communication apparatus.

In this example embodiment, the configuration example (a1) will be described. That is, in this example embodiment, a communication apparatus 100 includes the data acquisition unit 102, the specification unit 104, and the authentication information acquisition unit 106.

The configuration examples (a2) to (a3) including the server apparatus will be described later.

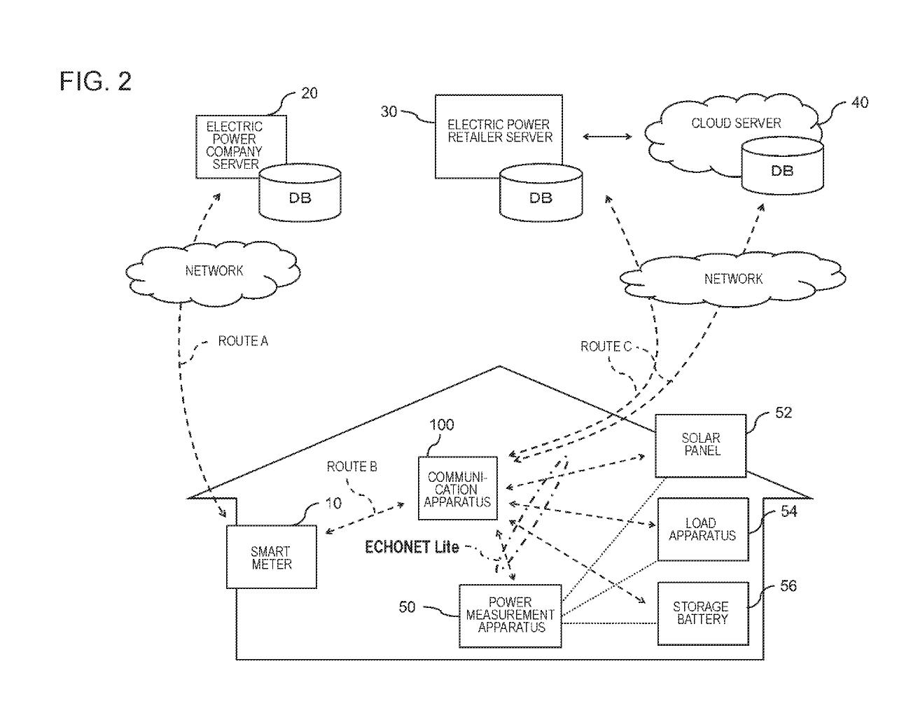

FIG. 2 is a conceptual diagram illustrating an example of the overall configuration of the information processing system 1 according to the example embodiment of the invention.

In the invention, a device refers to any of various devices requiring an authentication procedure using authentication information acquired by the authentication information acquisition unit 106 of the information processing system 1 of the invention. Examples of the device may include power-related apparatuses, for example, a power measurement apparatus 50 (may be included in a distribution board, and hereinafter, will also be referred to as a “distribution board”), a photovoltaic power generation apparatus (solar panel 52), a storage battery 56, and a load apparatus 54 such as a fuel cell (not shown), an electric vehicle (not shown), a plug-in hybrid vehicle (not shown), a water heater (not shown), ECHONET Lite (registered trademark) certified device such as an air conditioner, an illumination device, or the like, and other household appliances.

The power measurement apparatus 50 is connected to the power-related apparatuses such as the solar panel 52, the load apparatus 54, and the storage battery 56. The power measurement apparatus 50 may be included in a residential distribution board (not shown). In addition, for example, a current transformer (CT) is connected to the power measurement apparatus (distribution board) 50. A current waveform of the whole consumption current of the plural devices connected to the distribution board is acquired by the CT. The whole power consumption of all of the plural devices connected to the distribution board may be acquired by one CT or may be acquired by plural CTs.

The power measurement apparatus 50 may have a function of transmitting information related to the power usage of each device which is measured to the communication apparatus 100 through wireless communication. The communication apparatus 100 and the power measurement apparatus 50 may be one apparatus (for example, a home energy management system (HEMS) (not shown)) which has the functions thereof.

The smart meter 10 is an electricity meter having a communication function. For example, the smart meter 10 is supplied from an electric power company to a consumer. The electricity meter measures the consumption of power supplied from an electric power company or an electric power retailer. Information such as the measured power consumption is transmitted from the smart meter to an electric power company server 20 of the electric power company via so-called Route A on a regular basis.

A communication method between the smart meter 10 and the electric power company server 20 via the Route A may use, for example, but not particularly limited to, a specified low-power radio system using a frequency band of 920 MHz, or a mobile phone communication system such as a 3rd generation (3G), Long Term Evolution (LTE) or the like.

Further, the smart meter 10 may transmit information such as power consumption to the communication apparatus 100 such as a gateway via so-called Route B different from the Route A. A communication method between the smart meter 10 and the communication apparatus 100 via the Route B may use, for example, but not particularly limited to, a specified low-power radio system using a frequency band of 920 MHz, a communication system based on a communication standard such as WiSUN, or a communication system based on a wireless communication standard which works on IEEE802.15.4 such as Zigbee (registered trademark).

A communication system between the communication apparatus 100 and an electric power retailer server 30 or a cloud server 40 may use, for example, but not particularly limited to, a wireless communication system such as Worldwide interoperability for Microwave Access (WiMAX), 3G, or LTE.

In addition, a communication system between the communication apparatus 100 and each device such as the power measurement apparatus 50 may use, for example, but not particularly limited to, a specified low-power radio system using a frequency band of 920 MHz, a communication system based on a communication standard such as WiSUN, or a communication system based on a wireless communication which works on IEEE802.15.4 such as Zigbee (registered trademark). In this example embodiment, it is assumed that the communication apparatus 100 and each device such as the power measurement apparatus 50 communicate with each other in accordance with an ECHONET Lite communication standard.

Referring back to FIG. 1, the data acquisition unit 102 acquires time-series data measured with respect to the power consumption of a device.

The data acquisition unit 102 acquires data from the smart meter 10 or the power measurement apparatus 50.

In this specification, the term “acquisition” includes at least one of: an apparatus actively fetching data or information which is stored in another apparatus or a storage medium (active acquisition), including, for example, receiving data from another apparatus by making a request or inquiry to the apparatus, reading data stored in another apparatus or a storage medium by accessing the another apparatus or the storage medium, or the like; and an apparatus inputting data or information which is output from another apparatus (passive acquisition), including, for example, receiving data or information which is distributed (or which is transmitted, which is delivered with push notifications, or the like). In addition, the acquisition also includes selective acquisition of the received data or information or the selective reception of the distributed data or information.

First, a case where data is acquired from the smart meter 10 will be described.

The data acquisition unit 102 acquires time-series data of measurement values related to power consumption which are measured by the electricity meter (smart meter 10).

For example, the communication apparatus 100 includes an interface unit (not shown) that performs wireless communication with the smart meter 10 by a specified low-power radio system using a frequency band of 920 MHz. In this example embodiment, it is assumed that the communication apparatus 100 previously performs an authentication procedure for wireless communication with the smart meter 10 via the Route B and thus is set to be in a communicable state.

The data acquisition unit 102 acquires information of measurement values related to power consumption, which are measured by the smart meter 10, from the smart meter 10 via the Route B at predetermined time intervals. Regarding the time interval at which the information is acquired, when data is acquired at an interval of, for example, about 20 seconds to 10 seconds, the time-series data allows a feature value for identifying a device to be extracted. However, the invention is not limited thereto, and the time interval may be longer than the interval, or may be an interval equal to or less than several seconds.

In addition, the time interval may be appropriately changed, and may be changed in accordance with a predetermined collection period or a type of information. The time interval may be set to such an extent that a feature value for identifying a device can be extracted from time-series data and a load on the smart meter 10 does not become excessive. A method of setting (changing) the time interval may include, but not particularly limited to, setting the time interval by a user's operation using the user interface of the communication apparatus 100; receiving setting on a predetermined web page and causing a server to set the time interval in the communication apparatus 100 through a network; or changing the time interval in accordance with the version-up of a program (firmware) of the communication apparatus 100, an instruction received from the server through the network, or the like.

The measurement value related to power consumption which is acquired from the smart meter 10 includes at least one of, for example, an instantaneous power measurement value, an instantaneous current measurement value, and an instantaneous voltage measurement value. In addition, different information such as a power consumption integrated value (30-minute value) may be acquired. Note that, in the configuration of (a3) in another example embodiment, the data acquisition unit 102 may acquire pieces of information (data measured with respect to power consumption), which are collected by the electric power company server 20 from the smart meter 10 via the Route A, from the electric power company server 20.

The data acquisition unit 102 requests the smart meter 10 to transmit necessary data (for example, an instantaneous power measurement value) at predetermined time intervals, collects data in a predetermined period of time, and stores the collected data together with time information to set the stored data to be time-series data. The data acquisition unit 102 acquires data for a period of time which allows a feature value for identifying at least a device to be extracted, from time-series data. In addition, the predetermined period of time may not be a continuous period of time, and then data may be that over respective plural periods of time. In addition, there are circumstances when a device in a certain type may have a significant feature in a specific time slot, in this case further when, for example, the type of the device can be already known, data for a predetermined period of time including the time slot from which at least the feature of the device are detectable may be acquired.

The time-series data may be obtained by collectively acquiring data stored by the smart meter 10 for a predetermined period of time, or may be obtained by causing the communication apparatus 100 to request an instantaneous value of the smart meter 10 on a regular basis (at intervals of, for example, 20 seconds), to acquire the values each time, and to store the acquired values for a predetermined period of time.

The time-series data acquired from the smart meter 10 includes instantaneous values for each time, and thus waveform data of measurement values may be generated on the basis of the instantaneous measurement values and time information thereof by at least one of the data acquisition unit 102 and the specification unit 104.

The data acquisition unit 102 may acquire information of a measurement value related to power consumption from the smart meter 10 as described above, or may acquire information of a measurement value related to power consumption from the power measurement apparatus 50 as described below.

Next, a case where data is acquired from the power measurement apparatus 50 will be described.

The data acquisition unit 102 acquires measurement waveform data of measurement values related to the whole power consumption which are measured at a distribution board (power measurement apparatus 50) that distributes power to plural devices, as time-series data. The measurement values related to power consumption which are acquired from the distribution board (power measurement apparatus 50) include a measurement value of at least one of, for example, total consumption current, power, and voltage.

For example, as described above, a CT is connected to the distribution board, and a current waveform of the whole consumption current of all of the plural devices connected to the distribution board is acquired by the CT. For example, the communication apparatus 100 includes an interface unit (not shown) that performs wireless communication with the power measurement apparatus 50 or the CT by a specified low-power radio system using a frequency band of 920 MHz. In this example embodiment, it is assumed that the communication apparatus 100 has previously performed an authentication procedure for wireless communication with the power measurement apparatus 50 (or the CT) and thus is set to be in a communicable state.

The data acquisition unit 102 acquires a current waveform in a predetermined period of time from the power measurement apparatus 50 or the CT to set the acquired current waveform to be time-series data.

The power measurement apparatus 50 or the CT may be configured to store time-series data for a predetermined period of time. In this case, the power measurement apparatus 50 or the CT may transmit the time-series data for a predetermined period of time which is stored at a point in time when a request is received from the communication apparatus 100, to the communication apparatus 100, or the power measurement apparatus 50 may transmit stored data for a predetermined period of time after a request is received, to the communication apparatus 100.

In addition, as described above, the predetermined period of time may not be a continuous period of time, and then data may be that over respective plural periods of time. In addition, time-series data in a certain time slot may be specified and requested. Alternatively, time-series data for a predetermined period of time may be extracted from acquired data for a certain period of time. In addition, in a case where the power measurement apparatus 50 or the CT is not configured to store total consumption current, a value of the total consumption current may be transmitted from the power measurement apparatus 50 or the CT to the communication apparatus 100 while sampling is performed for a predetermined period of time after a request is received from the communication apparatus 100.

The specification unit 104 specifies a device corresponding to power consumption on the basis of the acquired time-series data. The specification unit 104 may acquire the time-series data which is measurement waveform data of power consumption from the smart meter 10, or may also acquire the time-series data from the power measurement apparatus 50 (or CT).

For example, the specification unit 104 specifies a device by extracting a feature value from the time-series data measured with respect to power consumption and comparing the extracted feature value with a feature value unique to the device, by using a device disaggregation technique. The specification unit 104 may specify not only a type of device such as an air conditioner or a television but also a model number of the device. Here, the “model number of device” is information for specifying a type of device, and may also be referred to as another terminology. The “model number of device” is information different from pieces of information, called a manufacturing number, a product number, and a product serial number, for identifying individual products.

Note that authentication information of the smart meter 10 may be acquired on the basis of the time-series data acquired from the distribution board by the CT or the like to perform authentication connection between the communication apparatus 100 and the device (smart meter 10).

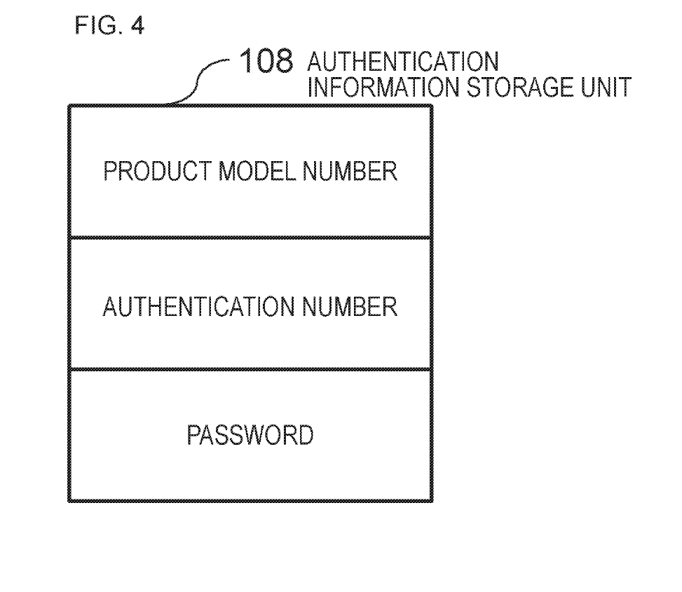

As illustrated in FIG. 4, the authentication information acquisition unit 106 acquires authentication information corresponding to the model number of the device which is specified by the specification unit 104, by referring to an authentication information storage unit 108 that stores authentication information set for each device or each model number of the device, the authentication information being, here, a pair of an authentication number and a password. The authentication information is not limited thereto, and may be a pair of predetermined identification information which is set for each device or each model number of the device, and a password or a passphrase which is associated with the identification information.

Authentication information used in an authentication procedure of a device may be often contained in a document, and the document may be included in the same package together with a product, or may be sent to a user of the device by post. In this case, the user should manually register the described authentication information in a communication apparatus. However, with the increasing number of digits of the authentication information of the device, the manual registration in the communication apparatus requires time and labor, and there is also a possibility of unsuccessful authentication due to erroneous input because of a large number of digits. In the invention, authentication information corresponding to the device is automatically acquired by specifying the device, and thereby making it possible to use the acquired authentication information for an authentication procedure.

As described later, a configuration may be adopted in which the authentication information acquired here is set to be an initial value, and authentication information for each user can be set later by a user. The authentication information storage unit 108 may be included in a memory (not shown) of the communication apparatus 100, or may be a storage device such as an external storage device accessible by the communication apparatus 100 or a web server to which the communication apparatus 100 can be connected through a network. A configuration in which authentication information is stored by the server apparatus corresponds to the above-described configuration (a2).

Access to each device performed by the communication apparatus 100 is allowed by an authentication procedure with each device.

In each device, authentication information is previously written in a memory (not shown) at the time of shipment or the like.

The communication apparatus 100 performs an authentication procedure to a device by using authentication information acquired by the authentication information acquisition unit 106. In a case of successful authentication, it is possible to communicate with the device. Each device compares the authentication information previously stored in the memory with authentication information transmitted from the communication apparatus. In a case where the pieces of authentication information are consistent with each other, authentication is completed, thereby allowing the communication apparatus 100 and the device to communicate with each other. On the other hand, in a case where the pieces of authentication information are not consistent with each other, authentication is not completed. In this case, the communication apparatus 100 and the device cannot communicate with each other.

In the invention, the purpose of an authentication procedure using authentication information is not limited. The authentication procedure may be an authentication procedure for performing communication between devices, or may be an authentication procedure for using a certain function of a device. For example, in a case where the device is an air conditioner, an illumination device, or the like, the authentication procedure may be for performing setting (turn-on/turn-off, temperature setting, and the like) of the device from the outside. In addition, various authentication contents are considered, and an authentication procedure for performing wireless communication based on an ECHONET Lite standard between the communication apparatus 100 and a device is performed in this example embodiment.

In this example embodiment, the communication apparatus 100 and the smart meter 10 or the communication apparatus 100 and a device such as the power measurement apparatus 50 communicate with each other by, for example, a specified low-power radio system using a frequency band of 920 MHz. Although not shown in the drawing, the communication apparatus 100 includes a communication unit that performs communication by a specified low-power radio system using a frequency band of 920 MHz.

It is assumed that the communication apparatus 100 has a communication function of communicating with the smart meter 10, the power measurement apparatus 50, the solar panel 52, the load apparatus 54, the storage battery 56, the electric power retailer server 30, or the cloud server 40 and includes a communication interface functional unit (not shown) corresponding to a communication system with each device or each apparatus.

The communication apparatus 100 performs an authentication procedure with a device by using authentication information acquired by the authentication information acquisition unit 106, and can communicate with the device in a case of successful authentication. For example, the communication apparatus 100 communicates with an air conditioner or a refrigerator which is a load apparatus in accordance with an ECHONET Lite standard, and thus can also perform control of not only turn-on/turn-off but also the setting of temperature, or the like.

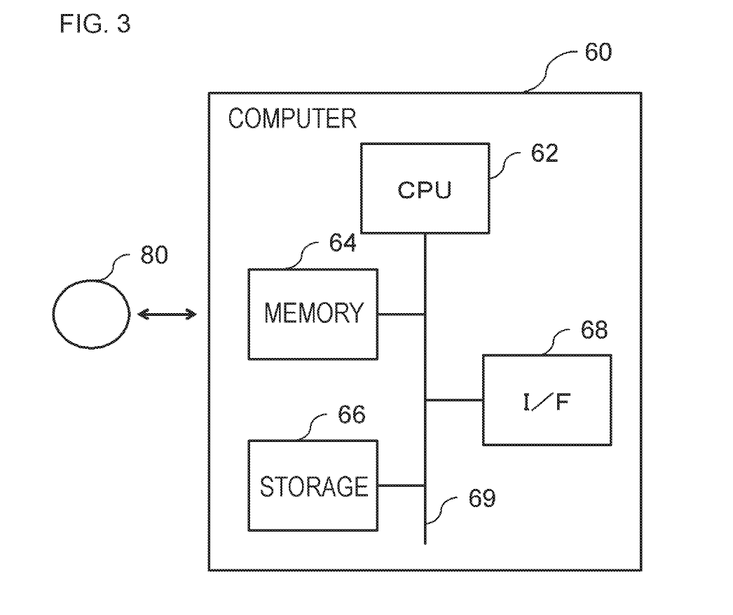

FIG. 3 is a block diagram illustrating a configuration example of a computer 60 for realizing the communication apparatus 100 of FIG. 2. In this example embodiment, the communication apparatus 100 is, for example, a mobile gateway that performs wireless communication with, for example, the smart meter 10 and each load apparatus 54 and performs wireless communication with the electric power retailer server 30 or the cloud server 40 via a Route C.

The computer 60 includes a Central Processing Unit (CPU) 62, a memory 64, a program 80 that realizes at least a portion of the components of FIG. 1 which are loaded into the memory 64, a storage 66 such as a hard disk which stores the program 80, and a network connection InterFace (I/F) 68. The components of the computer 60 are connected to each other through a bus 69, and the components and the entire apparatus realized by the computer 60 are controlled by the CPU 62.

The components of the information processing system 1 according to this example embodiment of FIG. 1 are realized by any combination of hardware and software of the computer 60 of FIG. 3. Those skilled in the art can understand that various modifications can be made to the realization method and the apparatus. Functional block diagrams illustrating information processing systems or apparatuses of the example embodiments to be described below show logical function-based blocks rather than hardware-based configurations. In addition, configurations of portions unrelated to the essence of the invention are not included and are not shown in the drawings.

The CPU 62 of the computer 60 of FIG. 3 reads the program 80 stored in the storage 66 to the memory 64 and executes the programs, and thus it is possible to realize functions of the units of FIG. 1 of the information processing system 1.

As described above, plural configuration examples of the information processing system 1 of the invention are considered, and the program 80 for realizing the information processing system 1 is executed by at least one computer 60. Since respective procedures of the program are executed by computers different for each of configuration examples, it is possible to consider various configurations in which any computer executes any procedures of the program.

It is assumed that this example embodiment corresponds to the above-described configuration (a1), and all units of the information processing system 1 of FIG. 1 are realized by the communication apparatus 100.

The computer program of this example embodiment is described so as to cause the computer 60 for realizing the communication apparatus 100 to execute a procedure of acquiring time-series data measured with respect to the power consumption of a device, a procedure of specifying the device corresponding to the power consumption on the basis of the acquired time-series data, and a procedure of acquiring authentication information of the specified device.

The computer program of this example embodiment may be recorded in a computer-readable recording medium. The recording medium is not particularly limited, and various configurations thereof are considered. In addition, the program may be loaded into a memory of a computer from the recording medium, or may be downloaded to the computer through a network to be loaded into the memory.

The recording medium having the computer program 80 recorded thereon includes a non-transitory tangible medium usable by the computer 60, and a program code readable by the computer 60 is embedded in the medium. When the computer program 80 is executed on the computer 60, the computer 60 is caused to perform the following control method for realizing an information processing apparatus (in this example embodiment, the communication apparatus 100).

An information processing method of the information processing system 1 according to this example embodiment which is thus constructed in this manner will be described below.

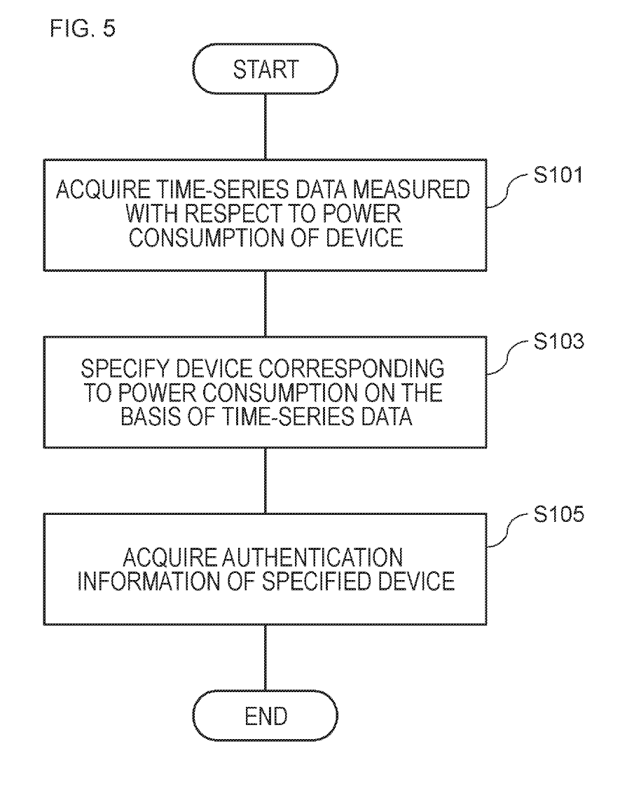

FIG. 5 is a flow chart illustrating an example of an operation of the information processing system 1 according to this example embodiment.

As described above, plural configuration examples of the information processing system 1 of the invention are considered. Thus, an apparatus (computer) performing procedures of the information processing method or a combination of apparatuses is different for each configuration example, and various configurations are considered with respect to by which of apparatuses (computers) which of procedures of the information processing method is performed.

(b1) An information processing method of a communication apparatus, the information processing method being performed by a computer realizing the communication apparatus

(b2) An information processing method of a communication apparatus and a server apparatus, the information processing method being performed by a computer realizing the communication apparatus and a computer realizing the server apparatus

In this example embodiment, the configuration (b1) will be described. The configuration (b2) will be described later.

In the configuration (b1), it is possible to cause the communication apparatus 100 to perform a procedure of the information processing method of the information processing system 1 by installing an application program for realizing the information processing system 1 in the communication apparatus 100 and starting up the application program.

In the configuration (b2), a user previously performs user registration for using a service of the information processing system 1, and the like and performs the setting of communication connection between the communication apparatus and the server apparatus.

The information processing method according to the example embodiment of the invention is an information processing method of an information processing apparatus (in this example embodiment, the communication apparatus 100) and is an information processing method which is performed by the computer 60 realizing the communication apparatus 100.

The information processing method of this example embodiment executed by the information processing apparatus (in this example embodiment, the communication apparatus 100), the method including acquiring time-series data measured with respect to the power consumption of a device (step S101), specifying a device corresponding to the power consumption on the basis of the acquired time-series data (step S103), and acquiring authentication information of the specified device (step S105).

In this example embodiment, the processing of the flow chart of FIG. 5 may be started by, for example, a user's request, may be performed in accordance with predetermined conditions, may be performed on any date and time, may be performed as needed, or may be performed on a regular basis. Various methods of receiving the user's request are considered, and the request may be received by pressing down an operation switch of the communication apparatus 100 or may be received by operating an operation button or an icon on a menu screen of the communication apparatus 100. Alternatively, an operation of starting to use a service of the information processing system 1 may be received by accessing a web page providing the service from a user terminal such as a smart phone, a tablet terminal, or a personal computer, and thereby the communication apparatus 100 may be instructed to start processing through a network.

An example in which authentication process between a device and the communication apparatus 100 is performed using the information processing method of the invention will be described in detail. In the device (for example, an air conditioner (company A, model number: ABC001)), authentication information including an authentication number and a password (authentication number: 12345678, password: abc987xyz654) is written in a memory (not shown) before shipment. The authentication information (authentication number: 12345678, password: abc987xyz654) is stored in the authentication information storage unit 108 in association with the model number (company A, model number: ABC001) of the device (air conditioner).

First, the data acquisition unit 102 acquires time-series data measured with respect to power consumption (for example, an instantaneous power measurement value acquired from the smart meter 10 at intervals of 20 seconds for a predetermined period of time) which includes the data of the device (air conditioner having a model number of ABC001 of the company A) (step S101). The specification unit 104 extracts a feature value of a power waveform on the basis of the acquired time-series data, and specifies a device corresponding to the power consumption (step S103). Here, the air conditioner having a model number of ABC001 of the company A is specified.

In step S101, time-series data may be acquired from the power measurement apparatus 50 or the CT. For example, the data acquisition unit 102 may acquire, as the time-series data, a power waveform for a predetermined period of time of total consumption current which is measured at a distribution board (power measurement apparatus 50) which distributes power to the device (air conditioner having a model number of ABC001 of the company A).

The authentication information acquisition unit 106 acquires authentication information (authentication number: 12345678, password: abc987xyz654) of the specified device (air conditioner having a model number of ABC001 of the company A) by referring to the authentication information storage unit 108 (step S105).

The communication apparatus 100 can perform an authentication procedure with the device (air conditioner having a model number of ABC001 of the company A) by using the authentication information (authentication number: 12345678, password: abc987xyz654) of the device (air conditioner having a model number of ABC001 of the company A) which is acquired by the authentication information acquisition unit 106 (not shown). In a case where the authentication is successful, wireless communication between the communication apparatus 100 and the device (air conditioner having a model number of ABC001 of the company A) is started (not shown). In a case where the authentication is not successful, wireless communication between the communication apparatus 100 and the device is not started.

In this case, a user may be notified of the failure of the authentication. A notification method is not particularly limited. For example, a notice may be displayed on a display unit (not shown) of the communication apparatus 100, or may be transmitted to the user's mail address, which is specified in advance, by mail.

As described above, in the information processing system 1 according to this example embodiment, time-series data related to the power consumption of a device is acquired from the smart meter 10 or the power measurement apparatus 50 (or the CT) by the data acquisition unit 102, and the device corresponding to the power consumption is specified by the specification unit 104 on the basis of the time-series data. Authentication information of the specified device is then acquired by the authentication information acquisition unit 106.

In this manner, according to the information processing system 1 of this example embodiment, when time-series data related to the power consumption of a device is acquired from the smart meter 10 or the power measurement apparatus 50 (or the CT), it is possible to specify the device on the basis of the acquired time-series data, to acquire authentication information of the specified device, and to use the acquired authentication information in an authentication procedure, and thus it is possible to simplify the authentication procedure of the device. For example, it is possible to reduce time and labor required for a user to input the authentication information and to prevent the authentication procedure from not being established due to an input error. The user does not need to perform a troublesome setting process for the device and can use the device only by a simple operation. For example, in a system capable of connecting a household electric appliance to an HEMS or the like and performing a remote operation, it is possible to simplify an authentication procedure for connecting the household electric appliance to a network, and the like, and a troublesome setting operation becomes unnecessary, thereby improving usability.

### Second Example Embodiment

Next, an information processing system according to a second example embodiment of the invention and an information processing method thereof will be described. Note that a program of this example embodiment causes at least one computer to perform the information processing method of the information processing apparatus similar to the above-described example embodiment, and a detailed description in this example embodiment will not be repeated.

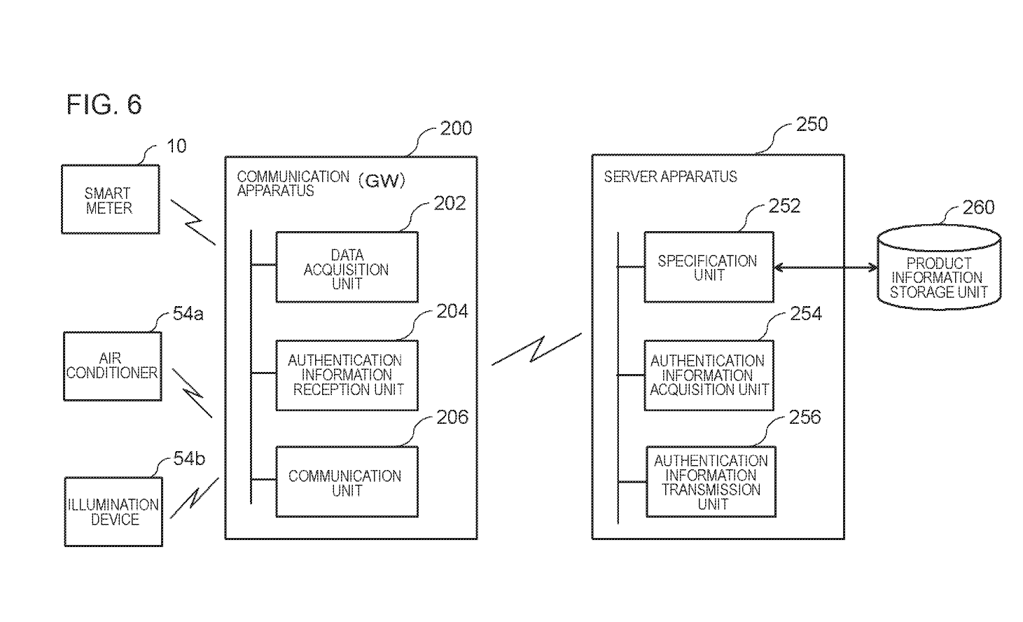

FIG. 6 is a functional block diagram illustrating a logical configuration of apparatuses of an information processing system 1 according to the example embodiment of the invention.

The information processing system 1 according to this example embodiment further has a configuration in which a server apparatus 250 manages authentication information which is used in an authentication procedure by the communication apparatus 100 of the information processing system 1 according to the above-described example embodiment. The information processing system 1 according to this example embodiment corresponds to the above-described configuration example of (a2) or (a3). Here, the configuration example of (a3) will be described.

In the information processing system 1 according to this example embodiment, a data acquisition unit 202 acquires time-series data related to the whole power consumption in plural devices. A specification unit 252 extracts time-series data of at least one device included in the plural devices from the acquired time-series data, and specifies the at least one device by using the extracted time-series data. An authentication information acquisition unit 254 acquires authentication information corresponding to the specified device.

As illustrated in FIG. 6, the information processing system 1 according to this example embodiment includes a communication apparatus 200 and a server apparatus 250. The communication apparatus 200 includes a data acquisition unit 202 and an authentication information reception unit 204. Further, the communication apparatus 200 may include a communication unit 206 that communicates with plural devices such as an air conditioner 54a and an illumination device 54b. The server apparatus 250 includes a specification unit 252 and an authentication information acquisition unit 254. Further, the server apparatus 250 may include an authentication information transmission unit 256.

In this example embodiment, the data acquisition unit 202 of the communication apparatus 200 and the specification unit 252 of the server apparatus 250 are equivalent to the data acquisition unit 102 of FIG. 1. The specification unit 252 of the server apparatus 250 is equivalent to the specification unit 104 of FIG. 1. Further, the authentication information transmission unit 256 of the server apparatus 250 and the authentication information reception unit 204 of the communication apparatus 200 are equivalent to the authentication information acquisition unit 106 of FIG. 1.

The server apparatus 250 of this example embodiment may be included in, for example, the cloud server 40 of FIG. 2. It is assumed that the communication apparatus 200 of this example embodiment can be connected to the server apparatus 250 via the Route C, similar to the communication apparatus 100 of the above-described example embodiment. A detailed description of communication between the communication apparatus 200 and the server apparatus 250 will not be repeated, and it is assumed that the apparatuses include respective interfaces for communication and communicate with each other in a state where security is secured by a predetermined connection procedure.

The cloud server 40 may be, for example, a server of a manufacturing company or a selling company of devices such as a solar panel 52, a load apparatus 54, and a storage battery 56. Alternatively, the cloud server may be a server of a service provider that provides a predetermined service to a user who possesses a certain device.

In the communication apparatus 200, the data acquisition unit 202 acquires time-series data related to the whole power consumption in plural devices. The authentication information reception unit 204 acquires authentication information of at least one device specified on the basis of the time-series data.

Further, the server apparatus 250 includes the specification unit 252 that acquires time-series data related to the power consumption of a device to specify the device corresponding to the power consumption on the basis of the time-series data and the authentication information transmission unit 256 that transmits authentication information of the device specified by the specification unit 252.

In the communication apparatus 200, the data acquisition unit 202 acquires time-series data measured with respect to the whole power consumption of plural devices including the air conditioner 54a, the illumination device 54b, and the like, from a smart meter 10 or a power measurement apparatus 50. For example, the data acquisition unit 202 acquires an instantaneous power measurement value, corresponding to the total power consumption of the plural devices, from the smart meter 10 at intervals of 20 seconds for a predetermined period of time, and sets the acquired values to be time-series data. Alternatively, the data acquisition unit 202 acquires a current waveform for a predetermined period of time from the power measurement apparatus 50 or the CT, and sets the acquired waveform to be time-series data. The instantaneous power measurement value, corresponding to the total power consumption of the plural devices, may not be acquired from the smart meter 10 at intervals of 20 seconds as described above, and may be acquired at intervals of 10 seconds to 20 seconds, several seconds, or the like.

In this example embodiment, the data acquisition unit 202 further transmits the acquired time-series data to the server apparatus 250. Note that, in a case of the above-described configuration (a2), the communication apparatus 200 includes a specification unit and an authentication information acquisition unit, and thus the data acquisition unit 202 does not need to transmit time-series data to the server apparatus 250.

In the server apparatus 250, the specification unit 252 acquires time-series data related to the whole power consumption of plural devices. Further, the specification unit 252 extracts time-series data of at least one device included in the plural devices from the acquired time-series data, and specifies the at least one device by using the extracted time-series data. The authentication information transmission unit 256 transmits authentication information corresponding to the specified device.

In more detail, in the server apparatus 250, the specification unit 252 receives the time-series data related to the whole power consumption in the plural devices from the communication apparatus 200. The specification unit 252 separates feature values of the time-series data received from the communication apparatus 200 to thereby extract a feature value of at least one device. The specification unit specifies the device model number corresponding to the extracted feature value. As described later, the server apparatus 250 may receive the time-series data from the power measurement apparatus 50 rather than from the communication apparatus 200. The server apparatus 250 may receive the time-series data from at least one of the communication apparatus 200 and the power measurement apparatus 50.

In this example embodiment, a product information storage unit 260 is connected to the server apparatus 250. The product information storage unit 260 stores the authentication information associated with at least model number of the device, similar to the authentication information storage unit 108 of FIG. 4. The product information storage unit 260 may be provided outside or inside the server apparatus 250.

The authentication information acquisition unit 254 has at least a function of the authentication information acquisition unit 106 according to the above-described example embodiment. The authentication information acquisition unit 254 acquires authentication information (an authentication number and a password) which corresponds to the model number of the device specified by the specification unit 252, by referring to the product information storage unit 260.

The authentication information transmission unit 256 transmits the authentication information acquired by the authentication information acquisition unit 254 to the communication apparatus 200. The authentication information transmission unit 256 of the server apparatus 250 may acquire, in accordance with a request from the communication apparatus 200, authentication information corresponding to the model number by referring to the product information storage unit 260 to transmit the authentication information to the communication apparatus 200.

Note that, in a case of the above-described configuration (a2), the communication apparatus 200 includes a specification unit and an authentication information acquisition unit, and thus, in the communication apparatus 200, the specification unit specifies a model number of a device and the authentication information acquisition unit sends a request attached with information of the model number of the device to the server apparatus 250.

The authentication information reception unit 204 receives authentication information transmitted from the server apparatus 250.

The communication unit 206 performs an authentication procedure with each device, for example, the air conditioner 54a or the illumination device 54b by using the authentication information acquired by the authentication information reception unit 204, and communicates with each device in a case where the authentication is successful.

An information processing method of the information processing system 1 according to this example embodiment which is configured in this manner will be described below.

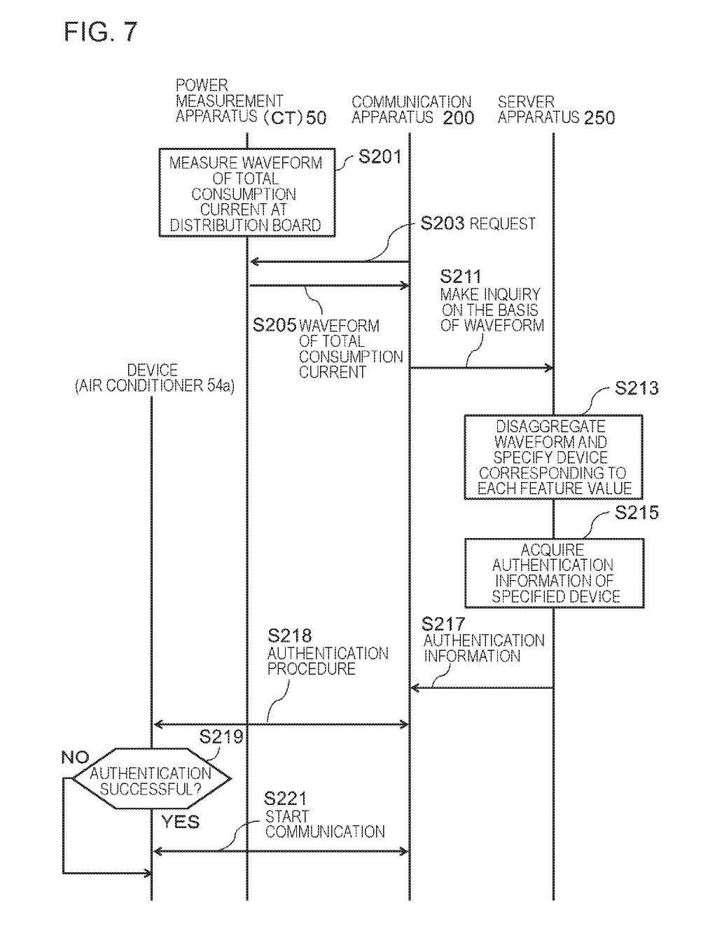

FIG. 7 is a flow chart illustrating an example of an operation of the information processing system 1 according to the example embodiment of the invention. Hereinafter, a case where waveform data of values of total consumption current is acquired from the CT connected to the power measurement apparatus (distribution board) 50 will be described as an example.

First, in the power measurement apparatus 50, the total consumption current of plural devices in the distribution board is measured using the CT (step S201). In the communication apparatus 200, the data acquisition unit 202 requests waveform data for a predetermined period of time of the total consumption current of the plural devices from the power measurement apparatus 50 (or the CT) (step S203). The waveform data for a predetermined period of time of the total consumption current of the plural devices is transmitted to the communication apparatus 200 from the power measurement apparatus 50 (or the CT), and is acquired by the data acquisition unit 202 (step S205).

The data acquisition unit 202 makes an inquiry to the server apparatus 250 about a device on the basis of the acquired waveform (step S211).

In the server apparatus 250, the specification unit 252 disaggregates the waveform transmitted from the communication apparatus 200 to thereby extract respective feature values, and specifies respective corresponding devices (step S213). Here, it is assumed that the air conditioner 54a and the illumination device 54b are specified. The authentication information acquisition unit 254 acquires authentication information of the devices specified in step S213 by referring to the product information storage unit 260 (step S215). Here, pieces of authentication information of the air conditioner 54a and the illumination device 54b are acquired. The authentication information transmission unit 256 transmits the authentication information of respective devices to the communication apparatus 200 (step S217).

In the communication apparatus 200, the authentication information reception unit 204 receives the authentication information of respective devices from the server apparatus 250, and the communication unit 206 performs an authentication procedure with respective devices (for example, the air conditioner 54a) by using the acquired authentication information (step S218). In FIG. 7, only the authentication procedure with the air conditioner 54a is shown, and an authentication procedure with the illumination device 54b is not shown.

In a case where the authentication is successful (YES in step S219), communication between the device and the communication apparatus 200 is started (step S221). In a case where the authentication is not successful (NO in step S219), communication between the device and the communication apparatus 200 is not started.

Note that the operation of the information processing system 1 in a case where time-series data related to power consumption is acquired from the smart meter 10 will be briefly described below.

First, in the communication apparatus 200, the data acquisition unit 202 requests an instantaneous power measurement value at intervals of 20 seconds for a predetermined period of time from the smart meter 10. The data acquisition unit 202 receives the instantaneous power measurement values which are transmitted from the smart meter 10 in accordance with the request. The data acquisition unit 202 transmits the instantaneous power measurement values for a predetermined period of time to the server apparatus 250 as time-series data.

In the server apparatus 250, the specification unit 252 extracts a feature value of a power waveform on the basis of the time-series data transmitted from the communication apparatus 200, and specifies a device corresponding to the power consumption. For example, the feature value of the power waveform is extracted on the basis of the time-series data, and a device corresponding to the power consumption is specified. A procedure after the device is specified is the same as the procedure from step S215 described above.

As described above, in the information processing system 1 according to this example embodiment, time-series data related to the power consumption of plural devices is acquired from the smart meter 10 or power measurement apparatus 50 (or the CT) by the data acquisition unit 202, and a model number of at least one device is specified on the basis of the time-series data by the specification unit 252. Authentication information of the specified device is acquired by the authentication information acquisition unit 254, and is transmitted to the communication apparatus 200 by the authentication information transmission unit 256.

In this manner, according to the information processing system 1 of this example embodiment, the same effects as those in the above-described example embodiment are exhibited. In addition, time-series data related to the power consumption of plural devices is acquired from the smart meter 10 or the power measurement apparatus 50 (or the CT), and at least one device is specified, thereby acquiring authentication information corresponding to the device. Thus, it is further possible to simply acquire authentication information for each device even when plural devices are present and to use the acquired authentication information in an authentication procedure of each device, and thus it is possible to simplify authentication procedures for the plural devices.

### Third Example Embodiment

Next, an information processing system according to a third example embodiment of the invention and an information processing method thereof will be described. Note that a program of this example embodiment causes at least one computer to perform the information processing method of the information processing apparatus similar to the above-described example embodiment, and a detailed description in this example embodiment will not be repeated.

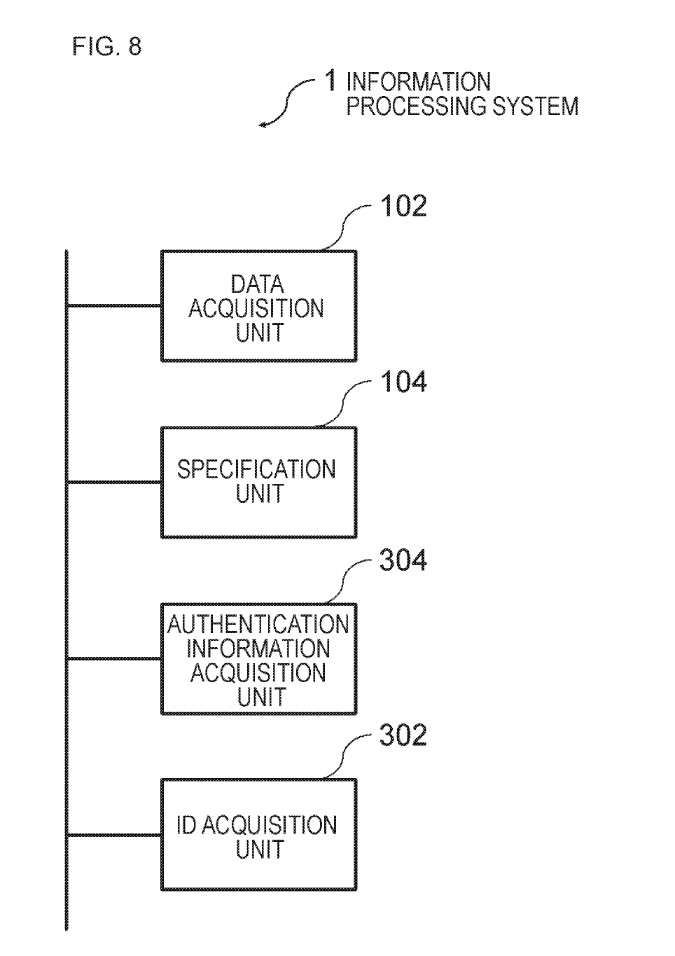

FIG. 8 is a functional block diagram illustrating a logical configuration of apparatuses of an information processing system 1 according to the example embodiment of the invention.

The information processing system 1 according to this example embodiment includes the data acquisition unit 102 and the specification unit 104 which are the same as those of the information processing system 1 according to the above-described example embodiment of FIG. 1, and further includes an identification information acquisition unit (ID acquisition unit) 302 and an authentication information acquisition unit 304.

The information processing system 1 according to this example embodiment is different from that of the above-described example embodiment in that an authentication procedure at a first stage is performed on the basis of authentication information assigned to the model number of the device to thereby start communication with a device, and thereafter individual identification information of the device and authentication information unique to the device are acquired to thereby perform an authentication procedure at a second stage.

This is because there is a possibility that discrimination cannot be performed based on individual levels even though discrimination can be performed based on model number levels in a case where a device disaggregation technique based on time-series data of a total measurement value of the power consumption of plural devices is used. For example, in a case where the device disaggregation technique is used, authentication is performed using the model numbers of the devices or information which is set for each model number. Since a large number of devices having the same model number are distributed, depending on the usage environment or conditions, the risk of being exposed to the threat of a fraud such as impersonation and the risk of suffering an inconvenience such as authentication failure or the freezing of a device or a communication apparatus due to the conflict of plural adjacent devices having the same model number are also considered. Consequently, in this example embodiment, a two-stage configuration in which authentication at a first stage using information of a model number level of the device is performed and when the authentication is successful, further authentication information is obtained is adopted and thereby the above-described problems can be solved.

In the information processing system 1 of this example embodiment, by using authentication information corresponding to the device which is acquired by the authentication information acquisition unit 304, an ID acquisition unit 302 acquires individual identification information from the device.

The authentication information acquisition unit 304 has the same function as that of the authentication information acquisition unit 106 of the above-described example embodiment, and further acquires authentication information of the device on the basis of the individual identification information.

The individual identification information of the device is information for identifying individual products which includes at least one of, for example, a Media Access Control (MAC) address, an Internet Protocol (IP) address, a manufacturing number, a product number, and a product serial number.

In the above-described example embodiment, an authentication procedure with a device is performed using first authentication information corresponding to a model number of the device, and communication is thus started. That is, for all devices having the same model number which are managed by a server, the authentication procedures are performed using the same authentication information. In this example embodiment, a configuration is further adopted in which the authentication procedures with respective devices are performed using second authentication information assigned to respective devices. Thereby, it is possible to perform authentication for each device, thereby improving security.

Various methods of acquiring the second authentication information are considered and described below, but are not limited thereto.

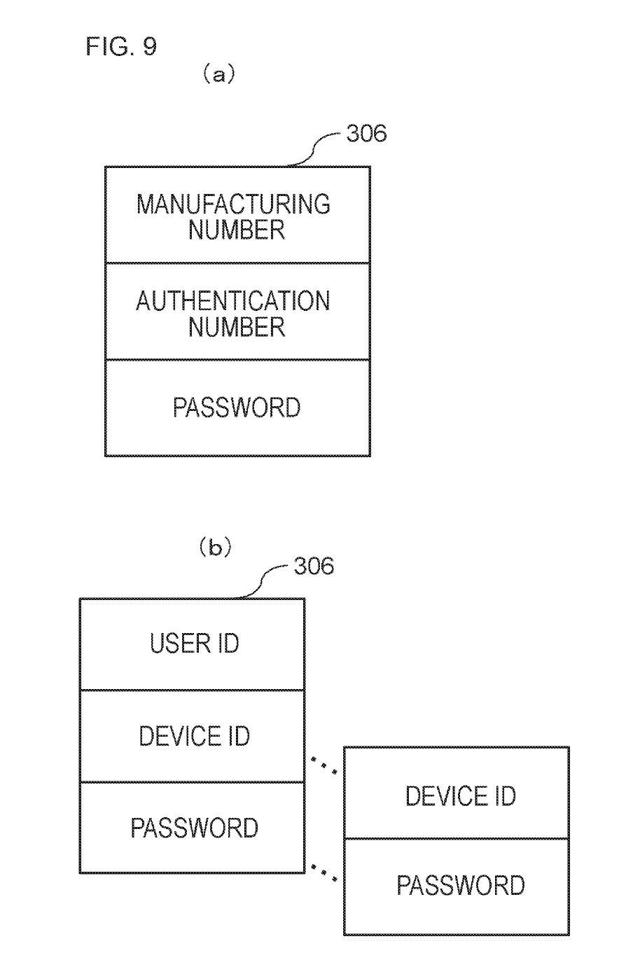

(c1) The second authentication information is associated with each piece of individual identification information (for example, a manufacturing number) of a device. In the device, the first authentication information and the second authentication information are written in a memory (not shown) of the device together with the manufacturing number before shipment. When the authentication information acquisition unit 304 acquires the second authentication information on the basis of the individual identification information, the device information storage unit 306 (FIG. 9(a)) is referred to. An authentication number and a password are stored in the device information storage unit 306 in association with the manufacturing number. Note that, the device information storage unit 306 may be provided outside or inside a server apparatus.

(c2) The second authentication information is generated by the authentication information acquisition unit 304 on the basis of the individual identification information of the device, and is written in the memories of the device and the communication apparatus. When the subsequent communication is started, an authentication procedure is performed using the second authentication information. The server apparatus may be notified of the authentication information. Alternatively, the server apparatus may generate the second authentication information on the basis of the individual identification information of the device to notify the device and the communication apparatus of the generated second authentication information.

(c3) A notification for promoting the registration of new authentication information (second authentication information) may be given to a user, and an authentication number (for example, a user ID) and a password which are arbitrarily set by the user may be received. The received second authentication information is written in the memories of the device and the communication apparatus. When the subsequent communication is started, an authentication procedure is performed using the second authentication information. The server apparatus may be notified of the authentication information. Alternatively, a configuration may be adopted in which a user accesses a web server and sets the second authentication information. The server apparatus may notify the communication apparatus and the device of the second authentication information which is set by the user.

In a case where the server apparatus manages the authentication information of the device in (c2) and (c3), a configuration may be adopted in which the device information storage unit 306 stores pairs of authentication number (shown as a device ID in the drawing) of the device and corresponding password for respective devices with respect to each user ID as illustrated in FIG. 9(b).

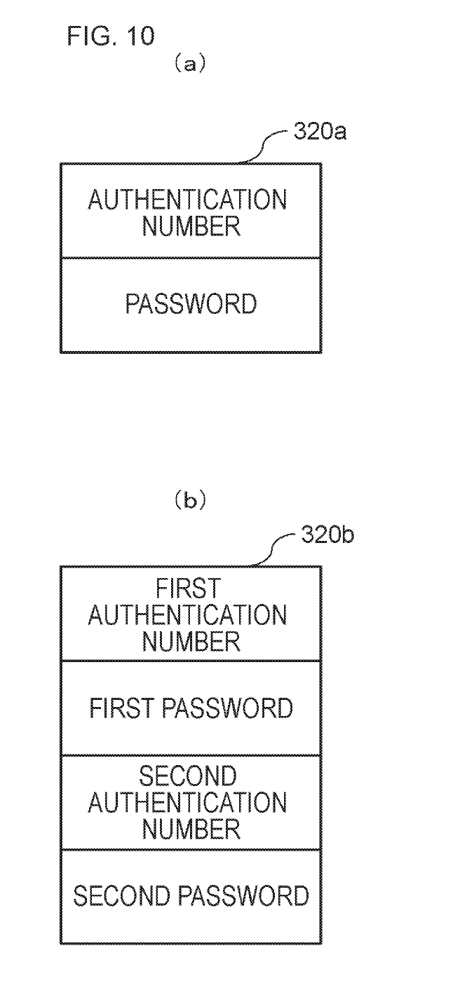

In this example embodiment, for example, the following two configurations are adopted: a configuration in which a device includes an authentication information storage unit 320a storing an authentication number and a password as illustrated in FIG. 10(a) and a configuration in which a device includes an authentication information storage unit 320b storing a first authentication number, a first password, a second authentication number, and a second password as illustrated in FIG. 10(b). Note that the authentication information storage unit 320a or 320b may be provided outside or inside the server apparatus.

In a case of the authentication information storage unit 320a of FIG. 10(a), when the first authentication information and the first password are stored in advance and the second authentication information is acquired by the authentication information acquisition unit 304, the authentication information storage unit 320a is overwritten with the second authentication number and the second password.

In a case of the authentication information storage unit 320b of FIG. 10(b), when the first authentication information and the first password are stored in advance and the second authentication information is acquired by the authentication information acquisition unit 304, the second authentication number and the second password are additionally stored in the authentication information storage unit 320b.

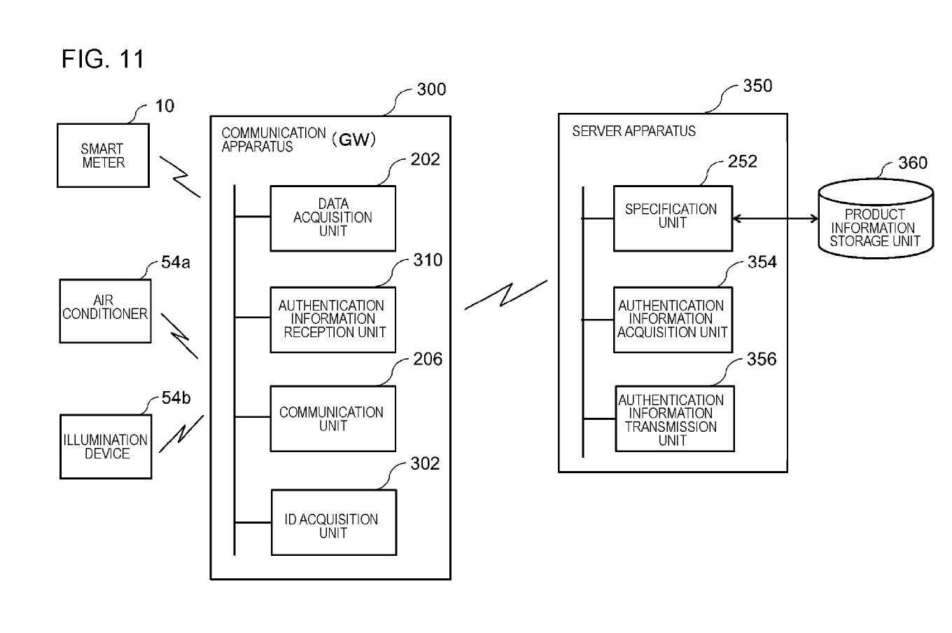

FIG. 11 is a functional block diagram illustrating an example of a configuration of the information processing system 1 according to this example embodiment.

In this example embodiment, the information processing system 1 includes a communication apparatus 300 and a server apparatus 350. The server apparatus 350 is connected to a product information storage unit 360. The product information storage unit 360 includes the device information storage unit 306 described in FIG. 9. Note that the product information storage unit 360 may be provided outside or inside the server apparatus 350.

The communication apparatus 300 includes a data acquisition unit 202 and a communication unit 206 which are the same as those of the communication apparatus 200 of FIG. 6, and includes an authentication information reception unit 310 and the ID acquisition unit 302 of FIG. 8. The authentication information reception unit 310 has the same function as that of the authentication information reception unit 204 of the communication apparatus 200 of FIG. 6, and further has a function of receiving the second authentication information from the server apparatus 350.

The server apparatus 350 includes a specification unit 252 which is the same as that of the server apparatus 250 of FIG. 6, and includes an authentication information acquisition unit 354 and an authentication information transmission unit 356. The authentication information acquisition unit 354 has the same function as that of the authentication information acquisition unit 304 of FIG. 8.

An information processing method of the information processing system 1 according to this example embodiment which is configured in this manner will be described below.

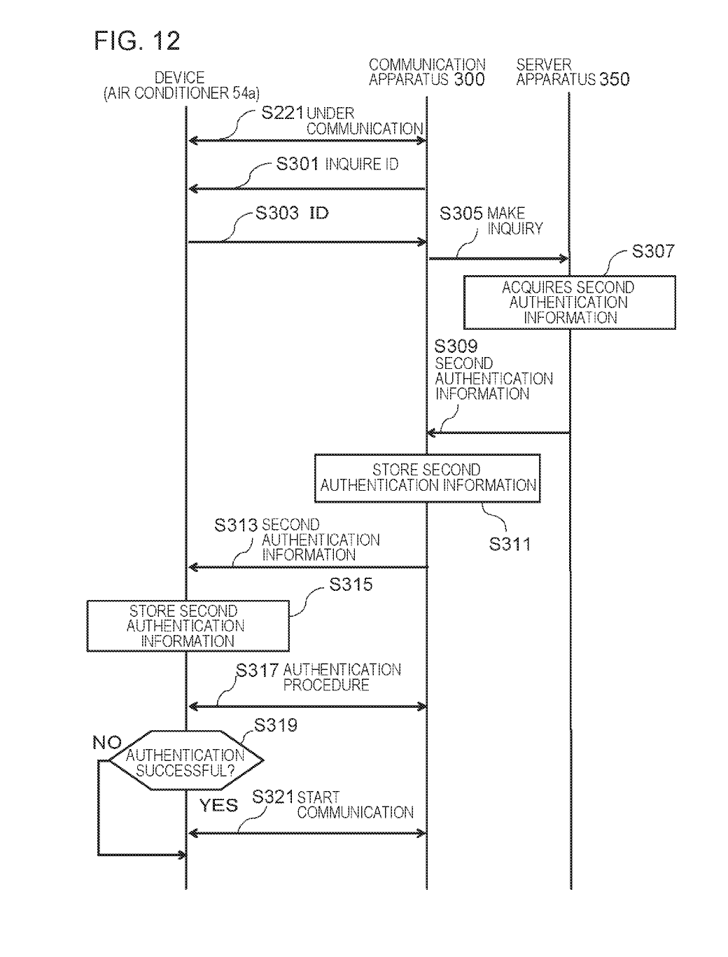

FIG. 12 is a flow chart illustrating the procedure of a process of acquiring second authentication information of the information processing system 1 according to this example embodiment.

In the device (air conditioner 54a) and the communication apparatus 300 that start to communicate with each other in step S221 of the flow chart of FIG. 7, the ID acquisition unit 302 of the communication apparatus 300 inquires individual identification information of the device (air conditioner 54a) (step S301). The individual identification information is replied from the device (air conditioner 54a) and is acquired by the ID acquisition unit 302 (step S303).

The authentication information reception unit 310 inquires second authentication information corresponding to the individual identification information of the device (air conditioner 54a) of the server apparatus 350 (step S305). In the server apparatus 350, the authentication information acquisition unit 354 acquires the second authentication information corresponding to the individual identification information of the device (air conditioner 54a) which is received from the communication apparatus 300 by referring to the product information storage unit 360 (step S307). The authentication information transmission unit 356 transmits the second authentication information acquired by the authentication information acquisition unit 354 to the communication apparatus 300 (step S309).

In the communication apparatus 300, the authentication information reception unit 310 receives the second authentication information from the server apparatus 350 and stores the received second authentication information in a memory (step S311). Further, the communication unit 206 transmits the second authentication information from the communication apparatus 300 to the device (air conditioner 54a) (step S313). The device (air conditioner 54a) stores the second authentication information received from the communication apparatus 300 in the authentication information storage unit 320 (step S315).

Thereafter, when the communication apparatus 300 communicates with the device (air conditioner 54a), the communication unit 206 performs an authentication procedure with the device (air conditioner 54a) by using the second authentication information in the communication apparatus 300 (step S317). In a case where the authentication is successful (YES in step S319), communication between the device (air conditioner 54a) and the communication apparatus 300 is started (step S321). In a case where the authentication is not successful (NO in step S319), communication between the device (air conditioner 54a) and the communication apparatus 300 is not started.

As described above, in the information processing system 1 according to this example embodiment, individual identification information acquired from the device by the ID acquisition unit 302 by using authentication information corresponding to a model number of the device, and authentication information (second authentication information) which is unique to the device, with respect to the device on the basis of the acquired individual identification information is acquired by the authentication information acquisition unit 304.

Thereby, according to the information processing system 1 of this example embodiment, the same effects as those in the above-described example embodiment are exhibited. It is possible that after an authentication procedure with a device is performed on the basis of first authentication information corresponding to a model number of the device, an authentication procedure is performed by setting second authentication information unique to the device for each device. Accordingly, it is possible to individually set authentication information with respect to devices having the same model number. Thereby, it is possible to further improve the level of security by a simple procedure.

As described above, the example embodiments of the invention have been described with reference to the accompanying drawings. However, the example embodiments are just illustrative of the invention, and various other configurations can be adopted.

For example, the communication apparatus of the invention may include an authentication information acquisition unit (equivalent to the authentication information acquisition unit 106 of FIG. 1, or the like) which acquires authentication information of a device corresponding to specified power consumption of the device on the basis of at least time-series data measured with respect to the power consumption.

In addition, the data acquisition unit 102 or the data acquisition unit 202 of the information processing system 1 of the invention may not be included in the communication apparatus. For example, the power measurement apparatus 50 may be configured to have a function of communicating with the server apparatus through a network. In this configuration, the power measurement apparatus 50 may transmit measured time-series data (power measurement value) to the server apparatus without going through the communication apparatus.

Specifically, a transmitter may be provided in a distribution board together with a CT, the measured time-series data (power measurement value) may be transmitted to the server apparatus from the transmitter, and the measured time-series data (power measurement value) may be transmitted to the server apparatus through a router different from the communication apparatus.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

Note that, in a case where information regarding the user is acquired and used in the invention, it is assumed that this is performed legitimately.

Hereinafter, an example of a reference configuration will be appended.

1. An information processing method executed by an information processing apparatus, the method including:

acquiring time-series data related to power consumption of a device;

specifying the device corresponding to the power consumption on the basis of the acquired time-series data; and

acquiring authentication information of the specified device.

2. The information processing method executed by the information processing apparatus according to 1, the method further including:

acquiring time-series data related to whole power consumption of plural devices;

extracting time-series data of at least one device included in the plural devices from the time-series data, and specifying the at least one device by using the extracted time-series data; and

acquiring authentication information corresponding to the specified device.

3. The information processing method executed by the information processing apparatus according to 2, the method further including:

acquiring individual identification information from the device by using the acquired authentication information corresponding to the device; and

acquiring authentication information of the device on the basis of the individual identification information.

4. The information processing method executed by the information processing apparatus according to any one of 1 to 3, the method further including:

acquiring measurement waveform data of a measurement value related to whole power consumption which is measured at a distribution board that distributes power to the plural devices, as the time-series data.

5. The information processing method executed by the information processing apparatus according to any one of 1 to 4, the method further including:

acquiring a measurement value related to the power consumption which is measured by an electricity meter, as the time-series data.

6. A program causing a computer to execute:

a procedure of acquiring time-series data related to power consumption of a device;

a procedure of specifying the device corresponding to the power consumption on the basis of the acquired time-series data; and

a procedure of acquiring authentication information of the specified device.

7. The program according to 6, causing the computer to further execute:

a procedure of acquiring time-series data related to whole power consumption of plural devices;

a procedure of extracting time-series data of at least one device included in the plural devices from the time-series data, and specifying the at least one device by using the extracted time-series data; and

a procedure of acquiring authentication information corresponding to the specified device.

8. The program according to 7, causing a computer to further execute:

a procedure of acquiring individual identification information from the device by using the acquired authentication information corresponding to the device; and

a procedure of acquiring authentication information of the device on the basis of the individual identification information.

9. The program according to any one of 6 to 8, causing a computer to further execute:

a procedure of acquiring measurement waveform data of a measurement value related to whole power consumption which is measured at a distribution board that distributes power to the plural devices, as the time-series data.

10. The program according to any one of 6 to 9, causing a computer to further execute:

a procedure of acquiring a measurement value related to the power consumption which is measured by an electricity meter, as the time-series data.

11. A method for controlling a communication apparatus executed by the communication apparatus, the method including:

acquiring time-series data related to power consumption of a device;

acquiring authentication information of the device corresponding to the power consumption on the basis of the acquired time-series data; and

performing an authentication procedure with the device by using the authentication information.

12. The method for controlling the communication apparatus executed by the communication apparatus according to 11, the method further including:

acquiring time-series data related to whole power consumption of plural devices; and

acquiring authentication information of at least one device specified on the basis of the time-series data.

13. The method for controlling the communication apparatus executed by the communication apparatus according to 12, the method further including:

acquiring individual identification information from the device by using the authentication information corresponding to the device; and

acquiring authentication information of the device on the basis of the individual identification information.

14. A program causing a computer to execute:

a procedure of acquiring time-series data related to power consumption of a device;

a procedure of acquiring authentication information of the device corresponding to the power consumption on the basis of the acquired time-series data; and

a procedure of performing an authentication procedure with the device by using the authentication information.

15. The program according to 14, causing a computer to further execute:

a procedure of acquiring time-series data related to whole power consumption of plural devices; and

a procedure of acquiring authentication information of at least one device specified on the basis of the time-series data.

16. The program according to 15, causing a computer to further execute:

a procedure of acquiring individual identification information from the device by using the authentication information corresponding to the device; and

a procedure of acquiring authentication information of the device on the basis of the individual identification information.

17. An information processing method executed by the communication apparatus, the method including:

acquiring time-series data related to power consumption of a device;

specifying the device corresponding to the power consumption on the basis of the time-series data; and

transmitting authentication information of the specified device.

18. The information processing method executed by the communication apparatus according to 17, the method further including:

acquiring time-series data related to whole power consumption of plural devices;

extracting time-series data of at least one device included in the plural devices from the time-series data;

specifying the at least one device by using the extracted time-series data; and

transmitting authentication information corresponding to the specified device.

19. A program causing a computer to execute:

a procedure of acquiring time-series data related to power consumption of a device;

a procedure of specifying the device corresponding to the power consumption on the basis of the time-series data; and

a procedure of transmitting authentication information of the specified device.

20. The program according to 19, causing a computer to further execute:

a procedure of acquiring time-series data related to whole power consumption of plural devices;

a procedure of extracting time-series data of at least one device included in the plural devices from the time-series data;

a procedure of specifying the at least one device by using the extracted time-series data; and

a procedure of transmitting authentication information corresponding to the specified device.

This application is based upon and claims the benefit of priority from Japanese Patent Application No. 2015-059514 filed on Mar. 23, 2015, the disclosure of which is incorporated herein in its entirety by reference.

1. An information processing system comprising:
a data acquisition unit that acquires time-series data related to power consumption of a device;
a specification unit that specifies the device corresponding to the power consumption on the basis of the acquired time-series data; and
an authentication information acquisition unit that acquires authentication information of the device specified by the specification unit.

2. The information processing system according to claim 1, wherein
the data acquisition unit acquires time-series data related to whole power consumption of a plurality of devices,
the specification unit extracts time-series data of at least one device included in the plurality of devices from the time-series data, and specifies the at least one device by using the extracted time-series data, and
the authentication information acquisition unit acquires authentication information corresponding to the specified device.

3. The information processing system according to claim 2, further comprising:
an identification information acquisition unit that acquires individual identification information from the device by using the authentication information corresponding to the device which is acquired by the authentication information acquisition unit,
wherein the authentication information acquisition unit acquires authentication information of the device on the basis of the individual identification information.

4. The information processing system according to claim 1,
wherein the data acquisition unit acquires measurement waveform data of a measurement value related to whole power consumption which is measured at a distribution board distributing power to the plurality of devices, as the time-series data.

5. The information processing system according to claim 1,
wherein the data acquisition unit acquires a measurement value related to the power consumption which is measured by an electricity meter, as the time-series data.

6. The information processing system according to claim 1, comprising a communication apparatus comprising the data acquisition unit, an authentication information acquisition unit, and an authentication unit,
wherein the authentication information acquisition unit acquires authentication information of the device corresponding to the power consumption on the basis of the acquired time-series data, and
the authentication unit performs an authentication procedure with the device by using the authentication information.

7. The information processing system according to claim 6, wherein
the data acquisition unit of the communication apparatus acquires time-series data related to whole power consumption of a plurality of devices, and
the authentication information acquisition unit of the communication apparatus acquires authentication information of at least one device specified on the basis of the time-series data.

8. The information processing system according to claim 7, wherein the communication apparatus further comprising:
an identification information acquisition unit that acquires individual identification information from the device by using the authentication information corresponding to the device,
wherein the authentication information acquisition unit acquires authentication information of the device on the basis of the individual identification information.

9. The information processing system according to claim 1, comprising a server apparatus comprising the data acquisition unit, the specification unit, and the authentication information transmission unit.

10. The information processing system according to claim 9, wherein
the data acquisition unit of the server apparatus acquires time-series data related to whole power consumption of a plurality of devices,
the specification unit of the server apparatus extracts time-series data of at least one device included in the plurality of devices from the time-series data, and specifies the at least one device by using the extracted time-series data, and
the authentication information transmission unit of the server apparatus transmits authentication information corresponding to the specified device.

11. An information processing method executed by an information processing apparatus, the method comprising:
acquiring time-series data related to power consumption of a device;
specifying the device corresponding to the power consumption on the basis of the acquired time-series data; and
acquiring authentication information of the specified device.

12. A non-transitory computer readable storage medium storing a program causing a computer to execute:
a procedure of acquiring time-series data related to power consumption of a device;
a procedure of specifying the device corresponding to the power consumption on the basis of the acquired time-series data; and
a procedure of acquiring authentication information of the specified device.
